(19) United States
(12) Patent Application Publication
(10) Pub. No.: US 2009/0175262 A1
(43) Pub. Date: Jul. 9, 2009

(54) VOIP With Internet Access

(76) Inventor: Sean Ryan, Laguna Beach, CA (US)

Correspondence Address: FISH & ASSOCIATES, PC;ROBERT D. FISH, 2603 Main Street, Suite 1000, Irvine, CA, 92614-6232, US

(21) Appl. No.: 11/969,409

(22) Filed: Jan. 4, 2008

(51) Int. Cl. H04L 12/66

(52) U.S. Cl. 370/352

(57) ABSTRACT

Systems and methods allow an analog phone line to concurrently carry both non-packetized data from a telephone handset and packetized data from a computer to a common network access number. An access device is provided to connect the handset and the computer to a common phone line, which provides both VoIP connectivity and Internet access. Since the access number is located within the user's local calling area, the inventive system avoids long distance charges that would otherwise be applied to Internet connectivity and long distance phone calls.

### FIELD OF THE INVENTION

The field of the invention is telephone and computer communication.

### BACKGROUND

It is known in the art to make phone calls using a plain old telephone system (POTS) telephone device and a public switched telephone system (PSTN). Within the PSTN framework, there is an exchange for long distance calls and there is an exchange for local calls. The circuit switched inter-exchange carrier (IXC) is used for long distance calls, and the local exchange carrier (LEC) is used for local calls. If the user dials a local number, the call is only routed to the LEC. If the user dials a long distance number, the call is first routed to the LEC, and then through the IXC.

Toll charges for long distance calls typically have two components, a LEC charge and an IXC charge. Charges for the IXC portion are often based upon (i) the length of time and (ii) distance between the parties, and can be expensive.

New technologies have emerged to ease the problem of expensive long distance telephone calls. Most notably, the Internet allows users to make long distance telephone calls via Voice-Over IP (VoIP) technology. As shown in U.S. Pat. No. 6,944,151 to Ménard, an IP network could concurrently provide a computer with Internet connection, and could enable a standard telephone to avoid IXC long distance charges. Ménard, however, requires the user to connect to the Internet before usage. Users who do not have a local Internet access point must first connect to the Internet using a long distance carrier, defeating the purpose of the invention. Additionally, Ménard passes analog signals from the telephone along the phone lines as packets for IXC charged phone calls. Packets transmitted within analog signals can be dropped, especially along phone lines that were never originally designed to carry packetized analog signals.

U.S. Ser. No. 11/566474 to Ryan et al, filed Dec. 4, 2006 is a continuation of utility application Ser. No. 11/538354 filed Oct. 3, 2006, which claims priority to provisional application no. 60/723,333, filed on October 3, 2005. Those applications all address additional aspects of related subject matter.

Ménard, Ryan and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

U.S. Pat. No. 7,050,426 to Veschi teaches a service where the user can dial a telephone number, and the telephone will automatically dial out to either a conventional carrier or a to a local VoIP provider. Similarly, a device called FaxSav™ produced by FaxSav Incorporation allows for the routing of a long distance number for faxing.

However, both Veschi and FaxSav still do not solve the issue of expensive long distance phone calls. Both devices require the caller to either pay-up front for a pre-set amount of minutes or pay on a minute by minute basis. While the bill may be reduced, users of these devices still have to be diligent in monitoring their usage since they are paying on a minute by minute basis. Additionally, neither Veschi nor FaxSav teaches using the VoIP provider to provide an Internet service other than VoIP.

Thus, there is still a need for a communication system that allows for inexpensive long distance calls and Internet connectivity, but is easy to use with existing POTS telephones and computers.

### SUMMARY AND PREFERRED EMBODIMENTS

The present invention provides apparatus, systems and methods in which an analog phone line concurrently carries both non-packetized data from a telephone handset and packetized data from a modem to a common network access number.

Preferred embodiments include two telephone connectors, an Ethernet connector, a modem, and appropriate circuitry. When a user dials a toll call or a long distance number, the circuitry can redirect the call to an access number different from the number dialed and avoid long distance charges by routing the call using VoIP. The circuitry can also pass the computer's digital signals through the phone line to the access number. This is especially advantageous to avoid long distance charges when the user's Internet Service Provider (ISP) is not located within the calling area. Preferably, a license to use the access number is offered for a single, fixed rate fee for permanent or periodic access.

The access number preferably connects the access device to a network of service centers that are capable of distinguishing between the packetized data and the non-packetized data, and route both using an Internet Protocol (IP). Preferably, third parties that own or operate the service centers are used, and are adapted or altered to accept incoming phone calls and remotely update the access device.

The access device can have an agent that facilitates remote updates, and an alarm that activates when an incoming phone call when the modem is in use. The alarm could be audio, visual, or tactile, and preferably communicates the identity of the caller to a user.

Since the access device could be configured to exclusively operate with either the handset or the computer, an indicator can be included that changes when the handset or the computer is in use. Preferably, when the handset is not in use, the modem is configured to automatically connect the computer to the network.

The access device preferably has an Ethernet connector to connect with a computer, but can alternatively connect to the computer using a wireless interface.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is perspective top view of a device according to the present inventive subject matter.

FIG. 2 is a perspective top of the device of FIG. 1, opened to show internal components according to the present inventive subject matter.

FIG. 3 is a schematic of the system (computer not shown) according to various aspects of the inventive subject matter.

FIG. 4 is a schematic of a telephone using the device of FIG. 1.

FIG. 5 is a schematic of an alternative embodiment of a system according to various aspects of the inventive subject matter.

FIG. 6 is a flow chart of a process of making a phone call using one of the inventive devices.

FIG. 7 is a flow chart of a process of connecting a computer to a network using one of the inventive devices.

### DETAILED DESCRIPTION

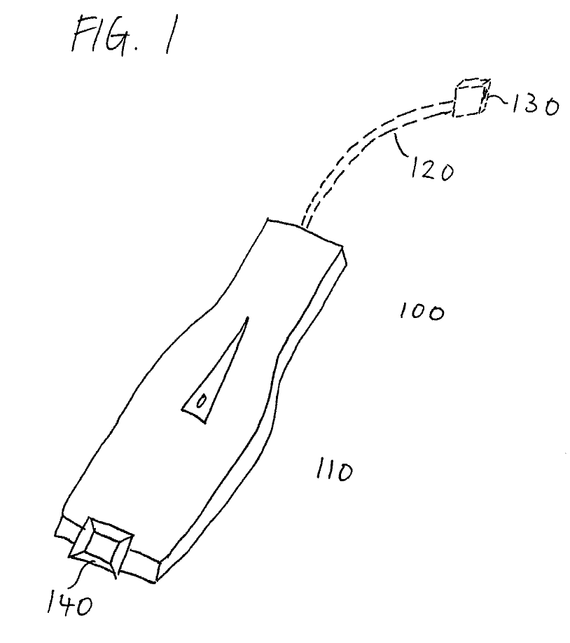

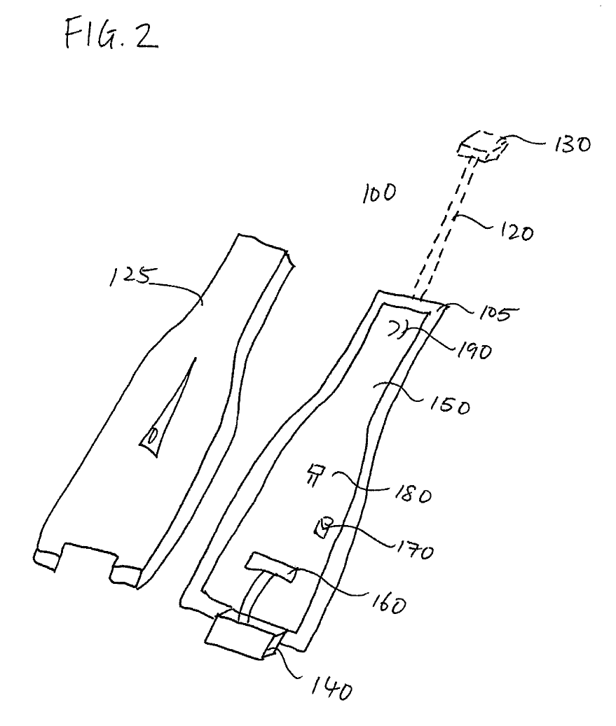

In an exemplary configuration depicted in FIGS. 1 and 2, a plug-in device 100 generally comprises a housing 110, an optional cord 120 with a male connector 130, a female connector 140, and a circuit board 150.

Housing 110 should be sufficiently large to provide adequate interfaces for the male connector 130, the female connector 140, and the circuit board 150. Preferably, housing has a bottom portion 105 and a top portion 125 in which each portion can be fitted together via screws (not shown). At the edge where bottom portion 105 and top portion 125 come together, there is an opening that allows female connector 140 to be exposed. It is also contemplated that bottom portion 105 has an opening on the opposite end of female connector 140 to allow cord 120 to extend itself from the inside of the housing to the outside. Cord 120 is optional and in its place, the device can have either a female or male connector to connect the housing to an external source.

All suitable variations are contemplated. For example, the female connectors in the housing 110 could be placed outside the housing using an extension. Similarly, one or more of the female connectors could be replaced by male connectors, and entirely different connectors could be used. For example, the Ethernet connector could be replaced by a Universal Serial Bus (USB) connector, another type of serial connector, or even a parallel connector. The modem could alternatively be disaggregated from the other components, and placed outside the housing. In that case, the device could still be considered to comprise the modem, only in a disaggregated configuration.

A preferred housing 110 is approximately 10 cm long, 5 cm wide and 1.25 cm thick, i.e., sized appropriately to house the various components. It is contemplated, however, that advances in technology would allow the housing to be smaller. More compact devices can be especially useful in settings where there is not much room for a plug-in device, such as between a wall and a bookcase. Thus, it is contemplated that the plug-in device should be compact and easy to inter change. It is also contemplated that housing 110 can be made of any material that is sufficiently durable, but preferably plastic. It may even be useful for the housing to provide some measure of water resistance, or even water proofing.

Cord 120 is can be made up with a group of wire strands bundled or twisted together as a functional unit and is attached to circuit board 150 and extends to male connector 130. Preferably, cord 120 is a pair of twisted telephone wires, but can be any other type of communication wires that transmits and receives a telephone signal. Cord 120 is preferably at least four (4) inches to accommodate attaching plug-in device 100 to a telephone device. However, cord can be as long as it needs to be to facilitate a connection between a telephone and plug-in device.

Male connector 130 is attached to cord 120, and constructed in such a way that it can be inserted snugly into a receptacle or a female connector to ensure a reliable physical and electrical connection. Male connector receives and transmits analog telephone data from a PSTN to plug-in device for any local calls. Typically, male connector would comprise a two- or three-prong plug attached to the end of the cord.

Female connector 140 is, of course, configured to receive male connector to provide a reliable physical and electrical connection. Female connector receives and transmits analog telephone data from the plug-in device to a telephone. Preferably, female connector 140 is attached by wires to circuit board 150. Female connector fits snuggly and is exposed at the edge between top and bottom portions of housing.

Both male and female connectors are also referred to as telephone jacks. The jacks are also known as registered jacks, sometimes described in a RJ-XX format, which are a series of telephone connection interfaces (receptacle and plug) that are registered with the U.S. Federal Communications Commission (FCC). There are three common RJ-XX type of jacks.

Preferably, plug-in device 100 is an adapter that uses a RJ-11 jack, which is the most common telephone jack and can have six conductors but usually is implemented with four. The RJ-11 jack is likely to be the jack that in everyday household or office phones are plugged into from the ordinary “untwisted” wire (sometimes called “gray satin” or “flat wire”) people are most familiar with. The four wires are usually characterized as a red and green pair and a black and white pair. The red and green pair typically carry voice or data. On an outside phone company connection, the black and white pair may be used for low-voltage signals such as phone lights. On a public system, they may be used for other kinds of signaling.

Twisted pair is the ordinary “copper wire” that connects home and many business computers to the telephone company. To reduce crosstalk or electromagnetic induction between pairs of wires, two insulated copper wires are twisted around each other. Each connection on twisted pair requires both wires. Since some telephone sets or desktop locations require multiple connections, twisted pair is sometimes installed in two or more pairs, all within a single cable. For some business locations, twisted pair is enclosed in a shield that functions as a ground. This is known as shielded twisted pair (STP). Ordinary wire to the home is unshielded twisted pair (UTP). Twisted pair is now frequently installed with two pairs to the home, with the extra pair making it possible to add another line (perhaps for modem use). Twisted pair comes with each pair uniquely color coded when it is packaged in multiple pairs. Different uses such as analog, digital, and Ethernet require different pair multiples.

Another common jack is the RJ-14. The RJ-14 is similar to the RJ-11, but the four wires are used for two phone lines. Typically, one set of wires (for one line) contains a red wire and a green wire. The other set contains a yellow and black wire. Each set carries one analog “conversation” (voice or data). Then, there is the RJ-45, which is a single-line jack for digital transmission over ordinary phone wire, either untwisted or twisted. The interface has eight pins or positions. There are two varieties of RJ-45: keyed and unkeyed. The keyed one has a small bump on its end and the female complements it. Both male connector and female connector must match.

In preferred embodiments, circuit board 150 is preferably disposed in housing as one unit, although it can be split among multiple components. FIG. 2 shows a preferred embodiment of circuit board 150, which comprises a chip 160, a power source 170, a signal indicator 180, and wires 190.

In another preferred embodiment, circuit board 150 can be any printed circuit boards (PCB) which are inexpensive and highly reliable. Preferably, circuit board can be produced using a silk screening method. But other methods of production, such as photoengraving or PCB milling can also be used.

Chip 160 is a digital component with miniature transistors that serves as the central processing unit in the plug-in device. The chip has two main functions. First, it sorts out the local telephone calls versus the long distance telephone calls, including local toll (calls that have the same area code, but nevertheless is considered to be a long distance call). Second, once chip 160 recognizes a long distance call, it encodes the analog signal of the call and sends it to a server with a local number through the local PSTN instead of a long distance PSTN. Thus, long distance charges will not apply. Once the server receives the call, a packet stream sends the analog signal to the analog signal into digitized packets and sends it via the Internet to a second server away from the first server. The second server then decodes the signals for transmission to another telephone. Preferably, chip is included in at least the housing of the plug-in device to facilitate the communications of all signals. It is also contemplated that chip may be programmed remotely. Furthermore, the chip receives signals from the first server and transmits the signals back to the telephone unit.

Preferred modules can advantageously include power source 170 to provide energy to plug-in device. Power source 170 has a power feed of no more than 15 Volts DC, although higher and lower power feeds are contemplated as required by the circuitry. Currently, the most preferred voltage is 10 V.

Signal indicator 180 is a light emitting diode and is also communicatively coupled to circuit board 150 by wires 190. Circuit board preferably controls power to signal indicator. The function of signal indicator is to indicate whether signals sent between the plug-in device from the wall jack to the telephone are being received. It is contemplated, when chip is receiving signals or in other uses, signal indicator can blink to indicate different transmission speed or whether it is being transmitted at all.

Signal indicators 180 preferred to emit visible light having a red color, but it can emit different colors. It should be understood by one of skill in the art that other types of light sources can be substituted for an LED (e.g. an incandescent bulb).

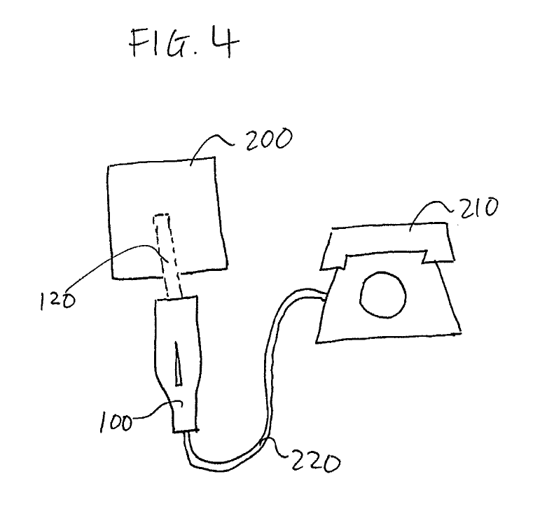

In an exemplary configuration as depicted in FIG. 4, plug-in device 100 is connected to a wall jack 200 and telephone unit 210.

Wall jack 200 can be any receptacle in a wall plate that when used with a plug make electric contact between circuits. In other words, wall jack transmits signals between telephone and the PSTNs. Plug-in device connects to wall jack via cord 120 by inserting male connector into female connector of wall jack.

Telephone unit 210 can be any plain old telephone system (POTS) telephone device, such as a touch-tone phone, a rotary phone, a cordless phone and so forth. It can also be a fax machine or other communication unit that can receive and transmit signals via a phone jack. Plug-in device connects to telephone 210 via a telephone cord 220.

In preferred embodiments, a user who wants to use the plug-in device simply needs to connect one end of the plug-in device to a wall jack and connect the other end to a telephone. After activating a service subscription, the telephone is ready to make both local and long distance calls according to the present inventive subject matter. Users can still use their standard existing home telephones with the plug-in device. No upgrades are necessary for any telephones to be function with the plug-in device. This not only cuts long distance costs, but prevents wasting standard existing telephones.

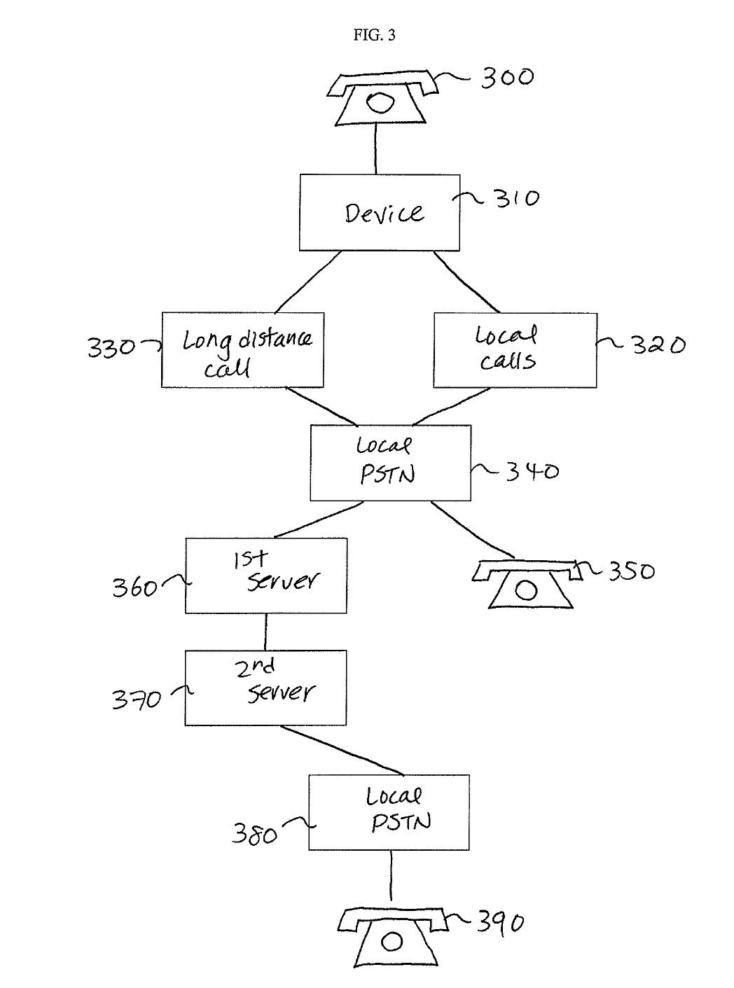

In preferred embodiments, it is contemplated as shown in FIG. 3, a caller using the plug-in device can make long distance and local calls by dialing from a first telephone 300, which will transmit the dialing data to a plug-in device 310, which then will pass a local number 320 to a local PSTN 340, which then passes the call to a second telephone 350. For long distance calls, the plug-in device passes a different access number, which will also go to a local PSTN. Upon receiving information for a long distance call, local PSTN 340 will transmit the data to a first server 360, which then sends the information to a second server 370 and then to another local PSTN 380 and finally to a third telephone 390 to complete the long distance call. The adapter contains no identifier that precludes its use on a third telephone instead of the first telephone.

It should be appreciated that telephone 300 is intended to be generic, including all manner of rotary and tone dial phones.

Dialing from a first telephone 300 can be performed on any ordinary landline telephone that transmits and receives signals across a network. Preferably, first telephone 300 is an old plain telephone set (“POTS”) such as a touch tone phone, a rotary dial phone, a cordless phone, or a fax machine. It is contemplated that multiple telephones can be used in a home or business.

Dialing data are transmitted to plug-in device 310 by having plug-in device connected to the telephone and the wall jack. Once numbers are entered into first telephone, the chip in plug-in device sorts out which number is a local number and which number is a long distance number. It is contemplated that an algorithm in the chip of plug-in device recognizes local number with shorter digits as to a long distance number. Preferably, plug-in device recognizes international long distance numbers as well as domestic U.S. long distance numbers.

For local number 320, plug-in device routes the call directly to user's telephone utility line or local PSTN 340 which will then transmit the voice signal from first telephone to second telephone 350. It is contemplated that local call charges apply. However, since most companies do not charge for local calls, users can enjoy unlimited usage of local calls without incurring an expensive telephone bill.

For long distance numbers 330, plug-in device recognize the number to be a long distance number and instead of passing it through the long distance PSTN, where toll charges will apply, it uses a different access number through the local PSTN. Preferably, the access number is a local number or a toll-free number dialed from first telephone 300 to first server. Since access number is a local number or a toll-free number (for example, a 1-800 number), no long distance charges will apply.

In preferred embodiments, PSTN 340 refers to the public switched telephone network. Long distance PSTN refers to the circuit switched inter-exchange (IXC)carrier for long distance calls. AT&T, SBC, Verizon, and Sprint are all examples of IXC carriers in America. Local PSTN refers to the local exchange carrier (LEC) that carries local calls.

First server 360 then receives signals from access number through local PSTN and is physically separated from the plug-in device. First server 360 is a server or a computer program which manipulates data. Preferably, first server can be any form, such as application servers, web servers, database servers, and so forth. In preferred embodiments, first server comprises the packet switched network is an Internet gateway server at a host site that digitizes an analog telephone signal into Internet protocol (IP) packages for transmission via the Internet. Similarly, first server is programmed to receive a call from local PSTN and to convert the analog signals from first telephone into digitized packets and send the packets into another server, second server.

In preferred embodiments, first server has the following main components: microprocessor, digital signal processor (DSP), modem chip, a data access arrangement or DM device, memory device and one or more Ethernet ports.

It is contemplated the microprocessor for first server process the following functions: 1) receives the analog signals from first telephone through access number; 2) converts the analog signals into digitized packets; 3) sends or transmits the digitized packets to a second server via the Internet. An analog signal received by microprocessor is sent to a digital signal processor. It is further contemplated that digital signal processor can turn analog signals received by first server from first telephone into digitized packets. Once the analog signals become digitized packets, microprocessor sends the digitized packets to second server.

In preferred embodiments, first server sends the digitized packets to a packet switched network (PSN). A PSN is a computer network where data is broken up and transmitted as individually addressed packets. For example, a PSN can be the Internet, which uses the TCP/IP protocol transfers data in packets. As each packet contains the destination address, packets may travel via different routes. The receiving device assembles the packets to recreate the original data. It is contemplated that the PSN also supports a virtual private network (VPN). A VPN is a private data network that utilizes a public telecommunication infrastructure. This creates a secure tunnel between the points within the VPN. Only devices with the correct code or key will be able to work within the VPN. The VPN network can be residing within a normal company LAN (Local Area Network), and/or over public networks such as Internet. For example, companies can use a system of VPN to create networks using the Internet as a medium for transporting encrypted data, such as voice signals. These systems use encryption and other security mechanisms to ensure that only authorized users can access the network and that the data cannot be intercepted. Providing a VPN allows different sites to be connected together over Internet in a safe and secure way and at a much lower cost.

It is further contemplated that first server adds a signal linking identifier to the series of digitized packets to second server. A signal linking identifier allows the receiving party to trace back the call to the first telephone. It can be a call-screening feature and include information such as the telephone number of the caller, the name of the caller, and time and day of the call.

Second server 370 is a server or a computer program which manipulates data. Preferably, second server can be any form, such as application servers, web servers, database servers, and so forth. In preferred embodiments, like first server, second server is an Internet gateway server at a host site. Second server is programmed to receive digitized packets from first server and convert the digitized signals back into analog signals and transmit the analog signals to a third telephone.

In preferred embodiments, second server has the following main components: microprocessor, digital signal processor (DSP), modem chip, a data access arrangement or DM device, memory device and one or more Ethernet ports.

It is contemplated the microprocessor for second server process the following functions: (i) receives digitized signals from first server through the Internet; (ii) converts the digitized packets back into analog signals; 3) sends or transmits the analog signals to a second local PSTN, which will send the analog signals to a third telephone. It is also further contemplated that second server adds a recognition to the second local PSTN.

It is further contemplated that digital signal processor for second server can turn digitized packets transmitted from first server back into analog signals. Once the digitized packets becomes analog signals, microprocessor of second server then send the analog signals to another local PSTN 380 which will then make a local call to third telephone 390.

Preferably, second server adds a recognition code to the signals passed along to the second telephone utility line. The recognition code is programmed to receive signals sent by first server's signal linking identifier. This enables receiver to receive the call-screening feature from caller that includes information such as the telephone number of the caller, the name of the caller, and time and day of the call.

Third telephone 390 is a land line based, analog, POTS telephone located long distance from first telephone. Without the use of plug-in device, any calls from first telephone to third telephone will have to go through long distance PSTN and be charged accordingly. With the use of plug-in device, once third telephone receives a call from local PSTN, second server then transmits the analog signals to third telephone. Then third telephone replies by retracing the pathway of the digitized signal from first telephone and establish a two-way real-time voice exchange. It is contemplated that there will be no real time delay between conversations since the transmission of the signals can be done instantaneously. This eliminates analog telephone calls to be routed through long distance PSTN without the need for a computer-computer exchange or a specialized VoIP phone. Both first and second server can provide sufficient resources to approximate real-time voice communication between the calling telephone and the target telephone. In preferred embodiments, it is contemplated that a conference call can be established with multiple telephones via the use of plug-in device.

In a particularly preferred embodiment, a service that can provide users a device and subscription for long distance calls via the Internet and without the use of any computer usage or special phones becomes cost effective for the users. Companies can market and advertise a telephone service which includes the selling of the plug-in device, the instructions for the plug-in device, and the flat-fee subscription to use the plug-in device with its servers. Although such services could be provided by any number of different companies, for purposes of this application it is named Chatter Bug.

In yet another preferred embodiment, all users would first subscribe to Chatter Bug for a flat fixed monthly fee to receive the plug-in device and services. The fee paid to Chatter Bug would facilitate the activation of plug-in device and the activation of the programming of Chatter Bug's Internet servers that facilitate unlimited long distance calls, including international long distance calls. The user then can connect the plug-in device on a household landline telephone and dial for unlimited long distance calls. Other types of flat fee subscription are also contemplated, including for example, a lifetime fee of a lump sum that enables the user to call without ever having to pay for long distance calls on a periodic basis. It is also contemplated that a minimal marginal cost could be low enough to effectively be a flat fee. For example, a system that charged one/thousandth of a cent per minute marginal cost is defined herein to effectively be the same as a fixed fee system. The dividing line is really one of human nature - at what point ordinary consumers would consider the marginal cost to be non-trivial.

Upon subscription, users can register their personalized information to receive the service either on a website or through a telephone number. Website registration is not necessary so users do not need to have Internet to use the plug-in device. Subscribers then only need to connect the plug-in device to their telephone and the phone jack to start using the services. The servers of Chatter Bug will recognizes the user's telephone numbers and can start to sort and route the local call versus the long distance calls. For website subscribers, they can also track phone call history and make any other changes, such as a telephone change with Chatter Bug on the website.

It is contemplated that long distance calls can include any national U.S. calls or any international calls. This is most advantageous for users who do not have any computers or special VoIP telephones to use VoIP technology for long distance calls. It is also advantageous because the receiver of the call from the user does not need to subscribe to the services to enjoy the long distance call. Furthermore, there is no extra step, such as dialing an extra “0” or “00”, involved for the user when dialing to another computer based telephone on the receiving end. The user is able to cut down costs on long distance bills dramatically from the uses of traditional long distance telephone companies by having a flat-fee based subscription.

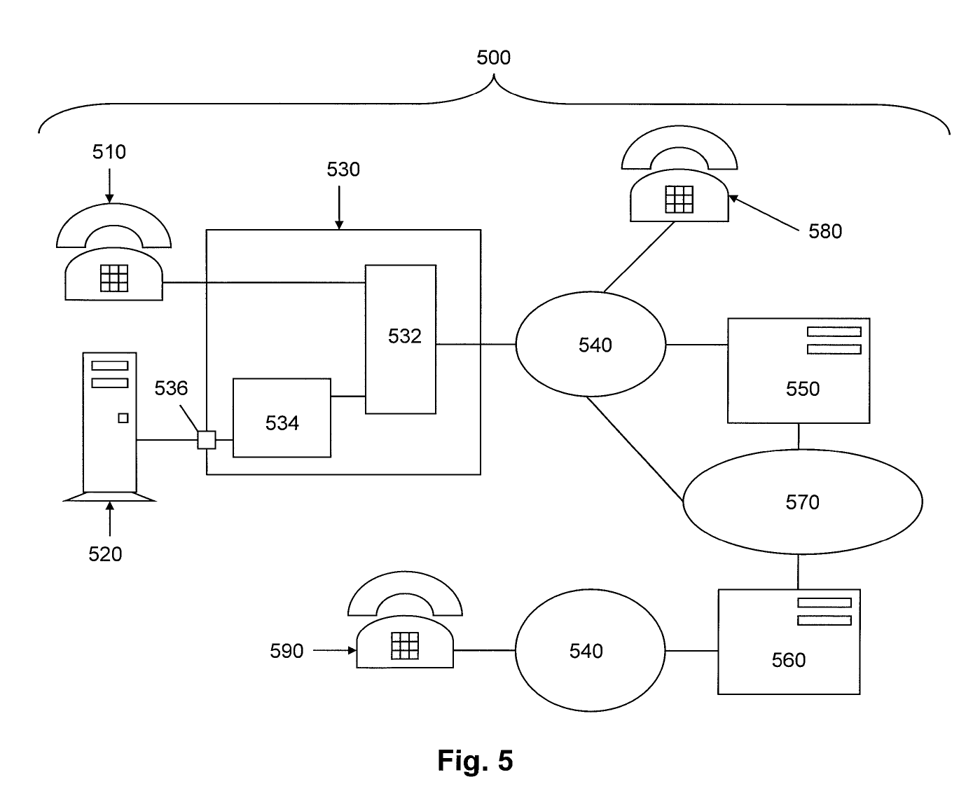

FIG. 5 shows an embodiment of an inventive system 500, with first telephone 510, computer 520, access device 530, PSTN 540, first server 550, second server 560, network 570, local telephone 580, and long distance telephone 590.

Access device 530 has similar VoIP functionality as device 310 in FIG. 3. A caller using access device 530 can make long distance and local calls by dialing a number with first telephone 510, which will transmit the dialed number to access device 530. If the dialed number is a local number, access device 530 will pass the dialed number to PSTN 540, which then passes the call to local telephone 580 as a non-packetized analog signal. If the dialed number is a long distance number, access device 530 will pass an access number, which is different from the dialed number) to PSTN 540, which then passes the call to first server 550 as a non-packetized analog signal. The first server 550 then encodes the call in digital packets and sends the signal through network 570 to second server 560. Second server 560 then decodes the digital packets and sends the call as a non-packetized analog signal through PSTN 540 to long distance telephone 590. This ensures that non-packetized analog signals are sent through the phone line 538 and POTS phones, and packetized digital signals are sent through the network and servers.

Access device 530 can also connect computer 520 to network 570. When a request to connect computer 520 to network 570 is made, access device 530 checks whether or not the ISP number is local. If the ISP number is local, access device 530 passes the ISP number to PSTN 540, which then connects the call to network 570 through the ISP (not shown). If the ISP number is a long distance number, the access device will pass the access number to PSTN 540, which then passes the call to first server 550 as a packetized analog signal, and which then connects the call to network 570 through the ISP (not shown).

In one embodiment without a DSL splitter, access device 530 allows only one of the telephone 510 and the computer 520 connects to the phone line 538 at any given time. In this case the access device 530 can advantageously provide a signal to the handset to alert a caller that the phone line is busy. One could alternatively or additionally have in indicator on the access device. Visual, audio, tactile, or even electronic signals are contemplated, and can merely indicate that the phone line is in use, or can deliver detailed information on the connected device.

The access device can also send an alarm when it receives an incoming call, but the computer is tying up the phone line. Contemplated alarms include a ring, a light, a message that appears on the computer screen, or even a caller ID display.

Access device 530 has similar components as plug-in device 100 in FIGS. 1 and 2, but also has redirector 532, modem 534, and modem port 536. Redirector 532 accepts a sent number and an analog signal, and routes the analog signal through the PSTN network to avoid a toll charge. If the sent number is a local number, redirector 532 will pass the sent number to PSTN 540. If the sent number is a long distance number, access device 530 will pass a different access number to PSTN 540 before later sending the sent number to PSTN 540. In one embodiment, redirector 532 passes the analog signal either from first telephone 510 or from modem 534 through the phone line. In a preferred embodiment, the redirector sends the analog signal from the first telephone and the analog signal from the modem concurrently through the phone line. This can be achieved with a DSL splitter or a similar device.

Modem 534 translates digital data packets into analog signals, and vice versa. Information sent to and from modem 534 and computer 520 is sent as a digital signal carrying packetized data, and information sent to and from modem 534 and redirector 532 is sent as an analog signal carrying packetized data. Modem 534 can be any suitable modem, for example a V.92 modem, V.90 modem, V.70 modem, V.34 modem, V.32 modem, or a modified DSL modem. A modified DSL modem is similar to a standard ADSL modem, but is configured to first call an access number before connecting to a DSL server. Preferably, modem 534 is a V.92 modem capable of putting the modem call “on hold” when the user wants to make or receive a phone call while connected to network 570.

Modem port 536 is a connector attached to modem 534 that is configured to connect to computer 520. Modem port 536 can be male or female, and be a standard RJ-XX jack, a USB connector, a DB9 connector, a DB 25 connector, or any other suitable connector that can transmit and receive digital signals. Preferably, modem port 536 is a standard female Ethernet RJ-45 connector.

The access device preferably also has an agent 537 that is used to update the software or firmware of the access device. Updates can be initiated from the access device itself, for example a weekly “heartbeat” check, or can be initiated from a remote service center that calls the access device. Updates generally consist of updating the database of access numbers, or updating the firmware of the circuitry, but other software or firmware can be updated by the agent as necessary.

Computer 520 is generally a desktop or a notebook computer, but can be any suitable dedicated electronic device, for example a router, a household appliance or a set-top box. Computer 520 is configured to communicate with network 570 through modem 534. Network 570 can be any computer network, but is preferably the Internet.

First server 550 and second server 560 can advantageously reside at networked service centers that provide VoIP connectivity. Many service networks already currently exist, and the provider of the access device can preferably contract with such service centers to reduce infrastructure costs. The infrastructure of the existing service network may need to be modified to accommodate the access device, for example by updating their caller ID database of allowed callers, or adding DSL filters that can separate analog signals carrying packetized data and analog signals carrying non-packetized data. The analog signals carrying packetized data are generally modulated into a digital signal and connected to an IP network, while the analog signals carrying non-packetized data are generally forwarded to a VoIP network.

In the case of a phone call from telephone 510, first server 550 and second server 560 are similar to first server 360 and second server 370 of FIG. 3, respectively. In the case of a modem phone call, first server 550 can forward the ISP number to second server 560 as a VoIP call. Preferably, first server 550 will analyze the ISP number and determine whether or not the service center has a contract with that ISP. If so, first server 550 can either directly provide connectivity to network 570 with a modem, or can forward the call to a dedicated ISP hub (not shown).

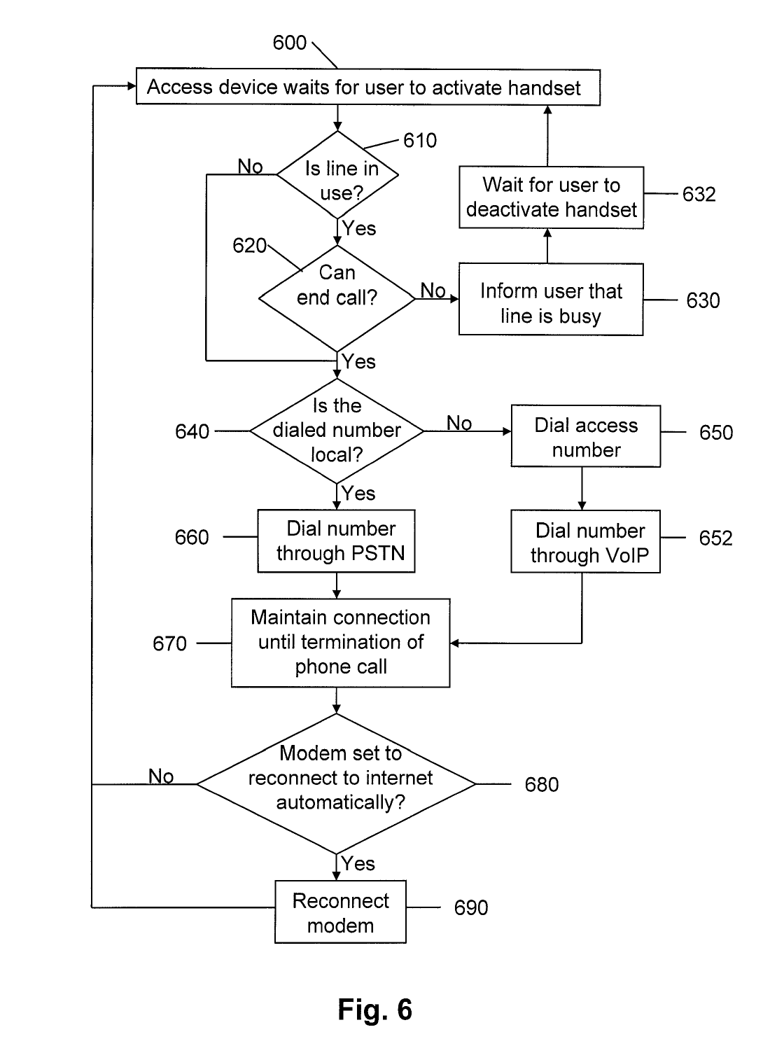

FIG. 6 depicts a process of making a phone call using the inventive subject matter. Initially, the access device waits for a user to activate the telephone, for example by picking up the handset or by hitting a speed-number dial (600). When the telephone is activated, the access device checks whether or not the phone line is in use (610). The access device could be set to end the present phone call when a user wants to make an outgoing phone call (620), or can simply inform the user that the line is busy (630). Once the phone line is not in use, the access device is free to connect the outgoing telephone call.

Once the access device receives the dialed number, the circuitry can check whether or not the dialed number is local (640). If the dialed number is local, the access device can merely pass the dialed number through to the local PSTN and maintain the connection until termination of the phone call (670). The phone call can be terminated by either calling party hanging up their telephone, or by a request by the access device itself. If the dialed number is not local, the access device first dials the access number (650) before sending the dialed number through the VoIP provider (652). The VoIP provider can then packetize the non-packetized analog signal and connect the call, maintaining connection until termination of the phone call (670).

Once the phone call terminates and the phone line is free again, the modem could be set to reconnect to the Internet automatically (680). This is especially advantageous when the inventive service is offered for a flat-fee, since the marginal cost to the user of using the phone line to maintain a constant Internet connection is zero. Whether or not the modem reconnects, the access device returns to its initial state of waiting for the user to activate the telephone (600).

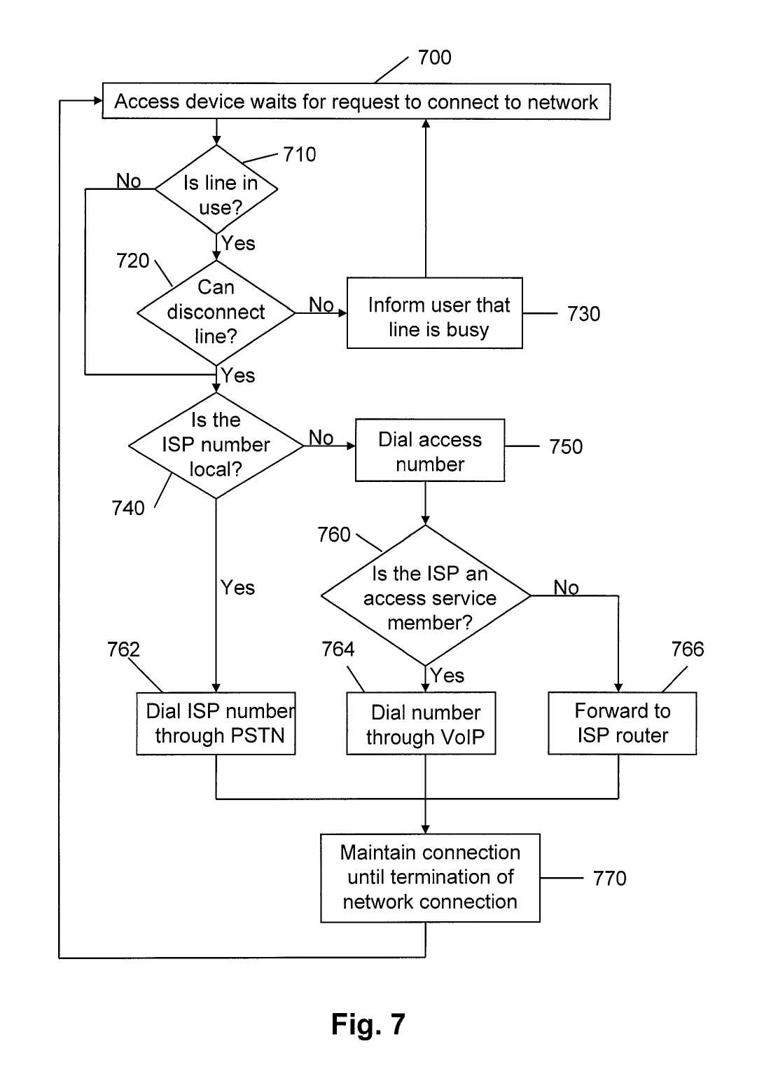

FIG. 7 provides a flow chart of a process of connecting a computer to a network using the present inventive subject matter. Initially, the access device waits for a request to connect to the network, which at this point in history is generally the Internet. The connection request can come from the access device itself, for example when the modem is set to reconnect to the Internet after a phone call terminates, or can come from another source, for example the computer could have a software that sends such a request. If the line is in use, (71 0), the access device first checks whether or not it has permission to automatically end the present phone call (720), and if it does not, it informs the user that the line is busy and returns back to the initial waiting state (700). After the phone line is no longer in use, the access device is free to connect the computer to the network.

The ISP number can be sent from the modem, the computer, or can be preprogrammed within the access device. If the ISP number is a local number, the access device can dial the ISP number through the local PSTN (762) and maintain connection until termination of the network connection. If the ISP number is not a local number, the access device first dials an access number (750) to connect to a local service center before forwarding the ISP number. If the ISP has a contract with the existing service center, the service center could forward the connection to an ISP router (766). Otherwise, a network connection could be established by connecting the modem call through VoIP (764). Preferably, if the ISP has a contract with the existing service center, the ISP number need not be sent to the service center at all, and steps 740 and 760 could be bypassed by the access device.

In the event that the service center has a DSL splitter that can separate analog signals carrying packetized data and analog signals carrying non-packetized data, the access device can initiate a call to the access number and provide both phone calls and DSL connectivity through the service center. While the line can be disconnected to dial emergency numbers (i.e. 911 in America) or at the user's whim, the line is preferably always connected to the service center to provide both network access and VoIP connectivity at all times.

Thus, specific embodiments and applications of the methods and apparatus of a telecommunication router have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. An access device for using an analog phone line to provide connectivity from at least one of a telephone handset and a computer, the device comprising:
circuitry configured to pass analog signals carrying non-packetized data to and from the handset and along the phone line, and to redirect toll call telephone numbers to an access number different from the toll call telephone numbers; and
a modem configured to pass digital signals to and from the computer and along the phone line as analog signals carrying packetized data.

2. The access device of claim 1, wherein the circuitry passes the digital signals through the phone line to the access number.

3. The access device of claim 1, wherein the non-packetized data and the packetized data are carried concurrently along the phone line.

4. The access device of claim 1, wherein the digital signals are passed to and from the computer through a wireless interface.

5. The access device of claim 1, further comprising an agent that facilitates remote programming of the access device.

6. The access device of claim 1, further comprising an alarm that indicates an incoming phone call when the modem is use.

7. The access device of claim 6 wherein the alarm comprises a caller ID display.

8. The access device of claim 1, further comprising an indicator that changes when the handset is in use.

9. The access device of claim 1, further comprising an indicator that changes when the modem is in use.

10. The access device of claim 1, wherein the modem is configured to automatically activate when the handset is not in use.

12. A method for enabling a user to connect both a telephone handset and a computer over an analog telephone line, comprising providing circuitry that:
passes analog signals carrying non-packetized data to and from the handset and along the phone line, and redirects toll call telephone numbers to an access number different from the toll call telephone numbers;
passes digital signals to and from the computer, and along the phone line, as analog signals carrying packetized data; and
wherein the non-packetized data and the packetized data are carried concurrently along the phone line to the access number.

13. The method of claim 1, further comprising charging a single, fixed rate fee for periodic access to the access number for both the non-packetized and packetized data.

14. The method of claim 1, further comprising providing the circuitry in an access box that includes a telephone connector, an Ethernet connector, and a modem.

15. The method of claim 1, further comprising providing a network of service centers capable of answering calls from the analog telephone line, distinguishing between the non-packetized data and the packetized data, and routing both the non-packetized data and the packetized data using an Internet Protocol (IP).

16. The method of claim 15, wherein the step of providing a network of service centers comprises contracting with third parties that own or operate different ones of the service centers.

17. The method of claim 1, further comprising providing a service that remotely updates the circuitry to redirect calls to a different access number.

18. A service center having first and second modems, and circuitry that:
accepts analog signals over the modems;
distinguishes between non-packetized data and packetized data within the analog signals;
routes the non-packetized data using a first packet transmission protocol; and
routes the packetized data using a second packet transmission protocol.

19. The service center of claim 18, wherein the first packet transmission protocol comprises Voice over Internet Protocol (VoIP).

20. The service center of claim 18, wherein each of the first and second packet transmission protocols comprise Internet Protocol.

21. The service center of claim 18, wherein each of the modems accept incoming phone calls.
